(19) United States
(12) Patent Application Publication
(10) Pub. No.: US 2025/0130138 A1
(43) Pub. Date: Apr. 24, 2025

(54) SYSTEM AND METHOD FOR DETECTING BEARING FAILURES FOR DISK GANG ASSEMBLIES OF AN AGRICULTURAL IMPLEMENT

(71) Applicant: CNH Industrial America LLC, New Holland, PA (US)

(72) Inventor: Scott Glovier, McMurray, PA (US)

(21) Appl. No.: 18/493,176

(22) Filed: Oct. 24, 2023

(51) Int. Cl. G01M 13/04; A01B 35/28; A01B 71/04; A01B 79/00

(52) U.S. Cl. CPC G01M 13/04; A01B 35/28; A01B 71/04; A01B 79/00

(57) ABSTRACT

A system for detecting bearing failures for disk gang assemblies of an agricultural implement includes a disk gang assembly having a shaft, a bearing rotatably supporting the shaft for rotation about a rotational axis, and a plurality of disks supported on the shaft for rotation with the shaft about the rotational axis. The system further includes a sensor provided in operative association with the bearing, with the sensor generating data indicative of a bearing-related parameter. The system may additionally include a computing system configured to receive the data generated by the sensor, convert the data to a frequency domain using a spectral analysis technique, and identify when the bearing is experiencing a bearing failure condition based at least in part on an evaluation of the data converted to the frequency domain.

### FIELD OF THE INVENTION

The present disclosure relates generally to agricultural implements and, more particularly, to systems and methods for detecting bearing failures for disk gang assemblies of an agricultural implement.

### BACKGROUND OF THE INVENTION

It is well known that, to attain the best agricultural performance from a field, a farmer must cultivate the soil, typically through a tillage operation. Modern farmers perform tillage operations by pulling a tillage implement behind an agricultural work vehicle, such as a tractor. Tillage implements typically include one or more tool assemblies configured to engage the soil as the implement is moved across the field. For example, in certain configurations, the implement may include one or more disk gang assemblies, leveling disk assemblies, rolling basket assemblies, shank assemblies, and/or the like. Such tool assemblies loosen and/or otherwise agitate the soil to prepare the field for subsequent planting operations.

Rotating tool assemblies, such as disk gang assemblies, basket assemblies, leveling disk assemblies, and the like, typically include one or more bearings that facilitate rotation of at least one component of the rotating tool assembly as an agricultural operation is being performed within the field. Over time, the bearing(s) of a given tool assembly will be subject to wear and tear, which can eventually result in failure of the bearing. Such bearing failures can result in the operation of the associated tool assembly being rendered ineffective or unsuitable for performing its intended function. However, it may be difficult for the operator to determine when a bearing failure has occurred relative to a given tool assembly.

Accordingly, systems and methods for detecting bearing failures associated with an agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for detecting bearing failures for disk gang assemblies of an agricultural implement. The system may include a disk gang assembly having a shaft, a bearing rotatably supporting the shaft for rotation about a rotational axis, and a plurality of disks supported on the shaft for rotation with the shaft about the rotational axis. The system may further include a sensor provided in operative association with the bearing, with the sensor being configured to generate data indicative of a bearing-related parameter. The system may additionally include a computing system configured to receive the data generated by the sensor, convert the data to a frequency domain using a spectral analysis technique, and identify when the bearing is experiencing a bearing failure condition based at least in part on an evaluation of the data converted to the frequency domain.

In another aspect, the present subject matter is directed to a method for detecting a bearing failure condition for a disk gang assembly of an agricultural implement. The disk gang assembly may include a shaft, a bearing rotatably supporting the shaft for rotation about a rotational axis, and a plurality of disks supported on the shaft for rotation with the shaft about the rotational axis. The method may include receiving, with a computing system, data generated by a sensor provided in operative association with the bearing, where the data may be indicative of a bearing-related parameter. The method may further include converting, with the computing system, the data to a frequency domain using a spectral analysis technique. Moreover, the method may include identifying, with the computing system, when the bearing is experiencing a bearing failure condition based at least in part on an evaluation of the data converted to the frequency domain. Additionally, the method may include performing, with the computing system, a control action associated with the agricultural implement when the bearing is identified as experiencing the bearing failure condition.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter, particularly illustrating the implement being towed by a work vehicle;

FIG. 2 illustrates another perspective view of the agricultural implement shown in FIG. 1 in accordance with aspects of the present subject matter;

FIG. 3 illustrates a perspective view of a ganged tool assembly of the implement in accordance with aspects of the present subject matter, particularly illustrating the ganged tool assembly configured as a disk gang assembly of the tillage implement;

FIG. 4 illustrates a partially exploded, perspective view of a support assembly for supporting the disk gang assembly of FIG. 3 in accordance with aspects of the present subject matter;

FIG. 5 illustrates a schematic view of a system detecting bearing failures for disk gang assemblies of an agricultural implement in accordance with aspects of the present subject matter;

FIG. 6 illustrates example data plots showing a monitored load in a time domain and converted to a frequency domain, particularly illustrating an example in which the disk gang assembly is experiencing a bearing failure condition in accordance with aspects of the present subject matter; and

FIG. 7 illustrates a flow diagram of one embodiment of a method for detecting bearing failures for disk gang assemblies of an agricultural implement in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for detecting bearing failures for disk gang assemblies of an agricultural implement. In several embodiments, a computing system may be configured to monitor a parameter associated with one or more bearings of a disk gang assembly that varies as a function of a condition of the bearing(s), thereby allowing the computing system to determine or infer when the bearing(s) is experiencing a bearing failure condition. For instance, in one embodiment, the monitored “bearing-related parameter” may be a load on the bearing(s), where the computing system is configured to analyze the load data to determine when the bearing(s) are experiencing the bearing failure condition (e.g., when the bearing(s) has one or more points of sticking). For example, the computing system may perform a spectral analysis technique (e.g., Fourier transform) on the load data to more easily identify when the bearing(s) is experiencing the bearing failure condition. When the magnitude of the load at the rotational frequency of the disk gang assembly (or multiple(s) of the rotational frequency) increases, such as compared to a maximum normal magnitude or compared to the magnitude of the load for another bearing(s) of the disk gang assembly, the computing system may determine that the bearing(s) is experiencing a bearing failure condition. Upon making such a determination, the computing system may be configured to automatically initiate a control action, such as by generating an operator notification and/or automatically adjusting the operation of the implement.

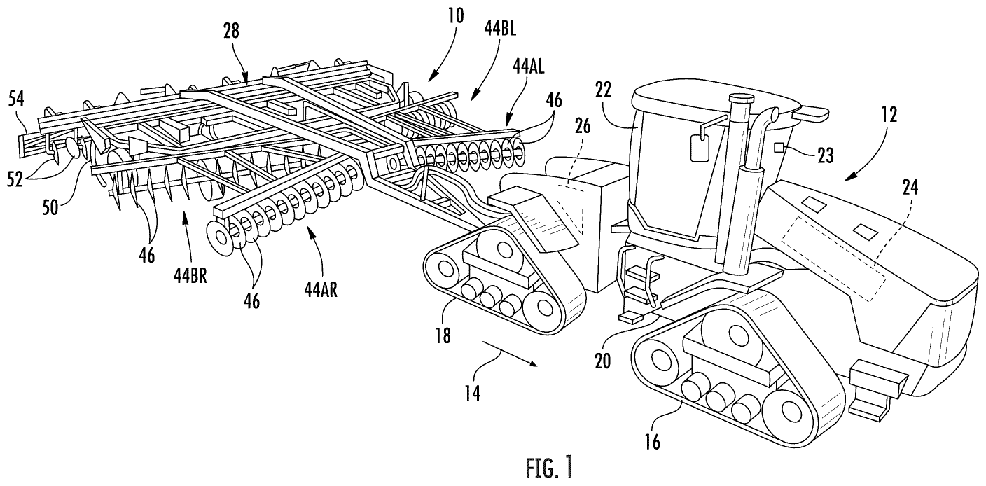

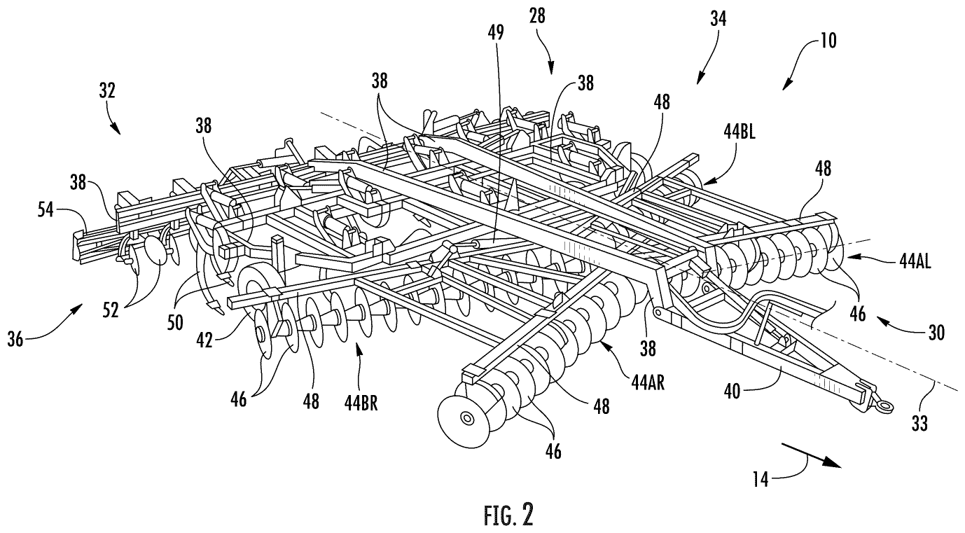

Referring now to the drawings, FIGS. 1 and 2 illustrate differing perspective views of one embodiment of an agricultural implement 10 in accordance with aspects of the present subject matter. Specifically, FIG. 1 illustrates a perspective view of the agricultural implement 10 coupled to a work vehicle 12. Additionally, FIG. 2 illustrates a perspective view of the implement 10, particularly illustrating various components of the implement 10.

In general, the implement 10 may be configured to be towed across a field in a direction of travel (e.g., as indicated by arrow 14 in FIG. 1) by the work vehicle 12. As shown, the implement 10 may be configured as a tillage implement, and the work vehicle 12 may be configured as an agricultural tractor. In other embodiments, the work vehicle 12 may be configured as any other suitable type of vehicle, such as an agricultural harvester, a self-propelled sprayer, and/or the like.

As shown in FIG. 1, the work vehicle 12 may include a pair of front track assemblies 16, a pair of rear track assemblies 18, and a frame or chassis 20 coupled to and supported by the track assemblies 16, 18. Alternatively, the track assemblies 16, 18 can be replaced with tires or any other suitable traction members. An operator's cab 22 may be supported by a portion of the chassis 20 and may house various input devices (e.g., a user interface 23) for permitting an operator to control the operation of one or more components of the work vehicle 12 and/or one or more components of the implement 10. Additionally, as is generally understood, the work vehicle 12 may include an engine 24 and a transmission 26 mounted on the chassis 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

As shown in FIGS. 1 and 2, the implement 10 may include a frame 28. More specifically, as shown in FIG. 2, the frame 28 may extend longitudinally between a forward end 30 and an aft end 32. The frame 28 may also extend laterally between a first lateral side 34 (e.g., a left side of the implement 10) and a second lateral side 36 (e.g., a right side of the implement 10), with a longitudinal centerline 33 of the implement frame 28 extending in the longitudinal direction between the forward and aft ends 30, 32 and generally dividing the first lateral side 34 from the second lateral side 36. In this respect, the frame 28 generally includes a plurality of structural frame members 38, such as beams, bars, and/or the like, configured to support or couple to a plurality of components. Furthermore, a hitch assembly 40 may be connected to the frame 28 and configured to couple the implement 10 to the work vehicle 12. Additionally, a plurality of wheels 42 (one is shown in FIG. 2) may be coupled to the frame 28 to facilitate towing the implement 10 in the direction of travel 14.

In several embodiments, the frame 28 may be configured to support one or more disk gang assemblies 44. As illustrated in FIG. 2, each disk gang assembly 44 includes a toolbar 48 coupled to the implement frame 28 and a plurality of harrow disks 46 supported by the toolbar 48 relative to the implement frame 28. Each harrow disk 46 may, in turn, be configured to penetrate into or otherwise engage the soil as the implement 10 is being pulled through the field. As is generally understood, the various disk gang assemblies 44 may be oriented at an angle relative to the direction of travel 14 to promote more effective tilling of the soil. In the embodiment shown in FIGS. 1 and 2, the implement 10 includes four disk gang assemblies 44 supported relative to the frame 28 at a location forward of the remainder of the ground-engaging tools. Specifically, the implement 10 includes a pair of front disk gang assemblies 44A (e.g., a left front disk gang assembly 44AL and a right front disk gang assembly 44AR) and a pair of rear disk gang assemblies 44B (e.g., a left rear disk gang assembly 44BL and a right rear disk gang assembly 44BR) positioned aft or rearward of the front disk gang assemblies 44A relative to the direction of travel 14 of the implement 10, with the left-side disk gang assemblies 44AL, 44BL being positioned on the left or first lateral side 34 of the implement 10 and the right-side disk gang assemblies 44AR, 44BR being positioned on the right or second lateral side 36 of the implement 10. It should be appreciated that, in alternative embodiments, the implement 10 may include any other suitable number of disk gang assemblies 44, such as more or less than four disk gang assemblies 44. Furthermore, in one embodiment, the disk gang assemblies 44 may be mounted to the frame 28 at any other suitable location, such as adjacent to its aft end 32. Moreover, the implement 10 may include one or more actuator(s) 49 (only one of which is shown) for adjusting the position of the toolbar(s) 48 relative to the frame 28 to adjust a penetration depth of the disks 46.

Additionally, as shown, in one embodiment, the implement frame 28 may be configured to support other ground-engaging tool assemblies. In the illustrated embodiment, the frame 28 is also configured to support one or more finishing tool assemblies, such as a plurality of leveler disk assemblies 52 and/or rolling (or crumbler) basket assemblies 54. However, in other embodiments, any other suitable ground-engaging tool assemblies may be coupled to and supported by the implement frame 28, such as a plurality of closing disks.

It should be appreciated that the configuration of the implement 10 described above and shown in FIGS. 1 and 2 is provided only to place the present subject matter in an exemplary field of use. Thus, it should be appreciated that the present subject matter may be readily adaptable to any manner of implement configurations.

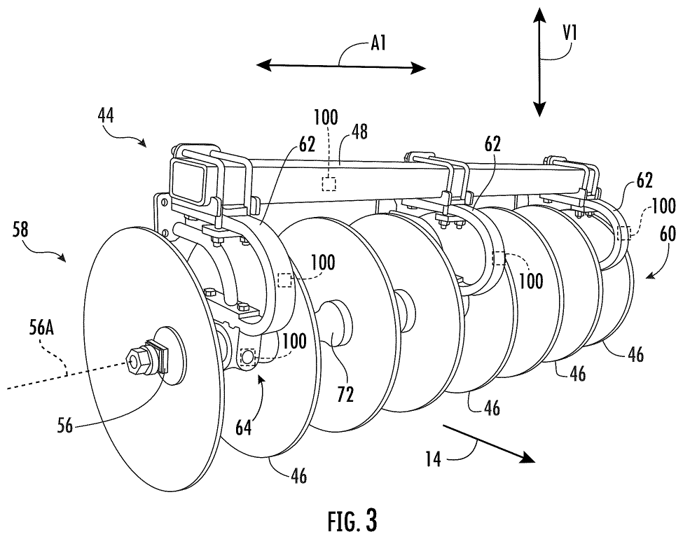

Referring now to FIG. 3, one example implementation of a disk gang assembly 44 described above in reference to FIGS. 1 and 2 is illustrated in accordance with aspects of the present subject matter. Specifically, FIG. 3 illustrates a perspective view of various components of the disk gang assemblies 44 of the implement 10 described above with reference to FIGS. 1 and 2. However, it should be appreciated that the aspects of disk gang assembly 44 described herein with reference to FIG. 3 may also be utilized with any other ganged tool assembly including any other suitable ground engaging tools of a given agricultural implement 10, such as individually mounted disks.

As shown in FIG. 3, the disk gang assembly 44 may include a plurality of disk blades 46 spaced apart along the length of a disk gang shaft 56 extending along an axial direction Al between a first end 58 and a second end 60. The disk blades 46 (alternatively referred to herein as “disks 46”) are generally configured to rotate about an axis 56A defined by the shaft 56. In one embodiment, the disks 46 are “keyed” to the shaft 56 such that all of the disks 46 rotate together about the axis 56A with the shaft 56. However, in other embodiments, the disks 46 may be allowed to rotate independently about the axis 56A relative to the shaft 56. The disk gang assembly 44 may also include a plurality of spools 72 positioned on the gang shaft 56, with each spool 72 extending axially between a pair of adjacent disks 46. For instance, each disk 46 is spaced apart from an adjacent disk 46 in the axial direction A1 via a respective spool 72 extending therebetween along the adjacent axial section of the gang shaft 56. As a result, an open space is defined between each pair of adjacent disks 46 in the axial direction A1 via the spacing provided by the associated spool 72.

The disk gang shaft 56 may be coupled to the toolbar 48 of the disk gang assembly 44 via one or more support assemblies such that the disk gang shaft 56 is positioned vertically below the toolbar 48 along a vertical direction (e.g., as indicated by arrow V1). For instance, each of the support assemblies includes a hanger 62 coupled at one end to the toolbar 48 and at the opposite end to the disk gang shaft 56. Specifically, in some embodiments, the hanger 62 is coupled to the disk gang shaft 56 by a bearing 64 supporting the disk gang shaft 56 for rotation.

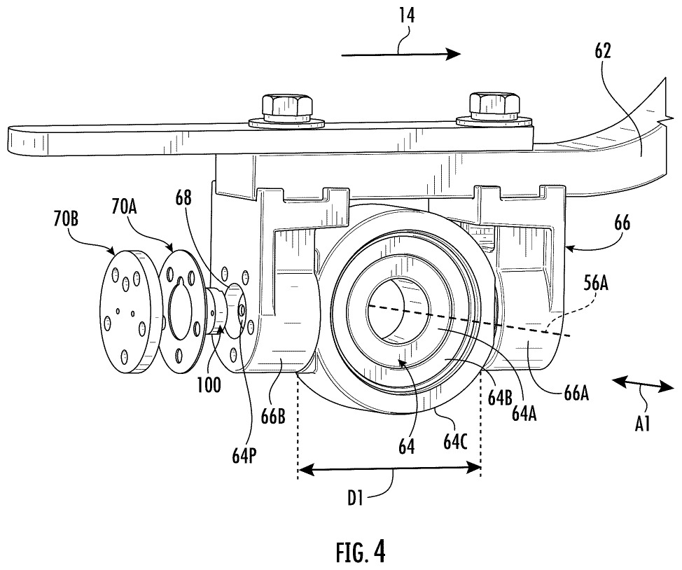

For example, as shown in FIG. 4, the bearing 64 may be supported by a support mount 66 relative to the hanger 62. More particularly, the support mount 66 may include a first mounting portion 66A and a second mounting portion 66B spaced apart in a direction D1 (e.g., where the direction D1 is perpendicular to the axis 56A of the disk gang shaft 56). In some instances, the first mounting portion 66A is forward of the second mounting portion 66B along the direction of travel 14. In one embodiment, such as the embodiment shown, the first and second mounting portions 66A, 66B are discrete parts, separately coupled to the hanger 62 by fastening elements (e.g., screws, bolts, rivets, etc.) or by any other means (e.g., welding, soldering, etc.). However, it should be appreciated that, in other embodiments, the first and second mounting portions 66A, 66B are portions of a unitary part which is coupled to the hanger 62. It should additionally be appreciated that, in one embodiment, the first and second mounting portions 66A, 66B collectively define or form a trunnion mount.

The bearing 64 may include an inner race 64A configured to receive, and be rotatably fixed to, the disk gang shaft 56 (FIG. 3) for rotation about the shaft axis 56A. The inner race 64A may be rotatably received within, and configured to be rotatable relative to, an outer race 64B. The outer race 64B may, in turn, be coupled to the mounting portions 66A, 66B such that the outer race 64B is held against rotation about the axis 56A. For instance, the outer race 64B may be received within, and rotatably fixed to, a mount 64C. The mount 64C may have a protrusion 64P extending outwardly from each of the forward end and the rearward end (only the protrusion 64P at the rearward end being shown) along the direction D1 for receipt within a respective opening 68 in the mounting portions 66A, 66B (only the opening 68 in the second mounting portion 66B being shown). It should be appreciated, however, that the mount 64C may instead be integral with the outer race 64B of the bearing 64.

Referring back to FIG. 3, in the illustrated embodiment, each of the hangers 62 defines a C-shape that permits the disk gang shaft 56 and the disk blades 46 mounted thereon to move relative to the toolbar 48. However, it should be appreciated that, in alternative embodiments, the hanger(s) 62 may have any other suitable configuration. It should additionally be appreciated that while the disk gang assembly 44 is shown as having three support assemblies in FIG. 3, the disk gang assembly 44 may have any other suitable number of support assemblies, such as two, four, five or more support assemblies.

With the disk gang assembly 44 positioned at its lowered or working position, the disks 46 of the assembly 44 may be configured to penetrate a soil surface of the field and rotate about the respective rotational axis 56A relative to the soil within the field as the implement 10 is moved across a field. The bearings 64 of the disk gang assembly 44 are typically subject to varying loading conditions, particularly as the disks 46 encounter differing soil conditions and objects within the soil (e.g., rocks, roots, etc.). Such variable loading leads to wear and tear on the bearings 64, which can eventually result in failure of one or more of the bearings 64.

Bearing failure typically occurs over an extended period of time, with the bearing(s) 64 transitioning over time from a normal, fully operational condition to a complete failure condition. During this transition process, the disk gang assembly 44 may be subjected to increased vibrations and loads (e.g., strain). For instance, the bearing(s) 64 may have one or more points that begin to stick cyclically, with the severity of such sticking increasing as the bearing(s) 64 transitions towards complete failure. As such, by monitoring a bearing-related parameter(s) (e.g., the load(s) at the bearing(s) 64) during the performance of a tillage operation, it may be inferred or determined when one or more of the bearing(s) of the gang assembly 44 is experiencing a bearing failure condition (including a complete failure condition of one of the bearings 64 and/or a partial failure condition as the bearing(s) 64 transitions between its fully operational condition and its complete failure condition).

Thus, as will be described in greater detail below, the bearing-related parameter(s) associated with a given disk assembly 44 may be monitored using one or more bearing sensors 100 provided in operative association with the disk assembly 44. For instance, as shown in FIG. 3, a bearing sensor 100 may be provided in association with at least one of the bearing(s) 64 to monitor the draft load at each of the associated bearing(s). The bearing sensor(s) 100 may be in contact with the bearing(s) 64 and/or on the hanger(s) 62 supporting such bearing(s) 64.

For example, in one embodiment, as shown in FIG. 3, the bearing sensor(s) 100 may be at least partially received within one or both of the opening(s) 68, between the protrusion 64P of the mount 64C and one or more retention plates 70A, 70B. In such embodiment, as the disks 46 move through a field, the bearing 64 may experience loads that cause the mount 64C to move along the direction D1. As such, the bearing sensor(s) 100 within the opening(s) 68 may be configured to monitor the portion of the load acting along the direction D1. For instance, in some embodiments, the bearing sensor(s) 100 within the opening(s) 68 directly contacts the respective protrusion 64P to detect the load on the bearing 64. It should be appreciated that, in such embodiments, the bearing sensor(s) 100 may be configured as any suitable type of draft load sensor. For instance, the bearing sensor(s) 100 may be a load cell, a force transducer, and/or the like.

It should be appreciated that, when one or more of the bearing sensor(s) 100 is alternatively, or additionally, provided in association with the hanger(s) 62, such bearing sensor(s) 100 may correspond to any suitable draft load sensor configured to directly or indirectly monitor the load, such as an accelerometer, an inertial measure unit (IMU), a strain gauge, and/or the like. It should further be appreciated that, in some embodiments, at least one bearing sensor 100 may be provided in association with at least two of the bearing(s) 64 of the disk gang assembly 44. Moreover, it should be appreciated that, in one embodiment, at least one bearing sensor 100 may be provided in association with each of the bearing(s) 64 of the disk gang assembly 44. Additionally, it should be appreciated that the bearing sensor(s) 100 may be positioned at any other suitable location to generate data indicative of the bearing-related parameter on the bearing(s) 64.

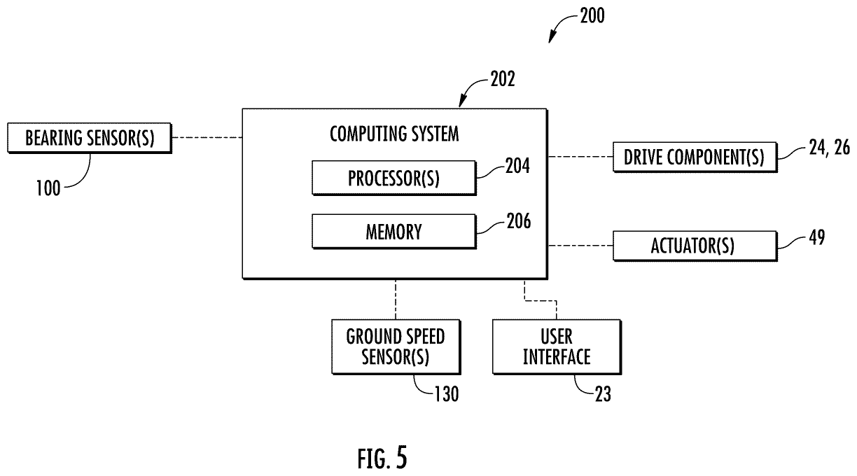

Referring now to FIG. 5, a schematic view of one embodiment of a system 200 for detecting bearing failures of disk gang assemblies of an agricultural implement is illustrated in accordance with aspects of the present subject matter. In general, the system 200 will be described herein with reference to the implement 10 and related disk gang assemblies 44 described above with reference to FIGS. 1-4. However, it should be appreciated by those of ordinary skill in the art that the disclosed system 200 may generally be utilized with agricultural implements having any other suitable implement configuration and/or with disk gang assemblies having any other suitable gang configuration. Additionally, although the system 200 will generally be described with reference to disk gang assemblies, the system 200 may generally be used to detect bearing failures associated with any other tool assemblies that include or incorporate bearings, such as basket assemblies, leveler disk assemblies, and/or any other suitable rotating tool assemblies.

In general, the system 200 may include, or be in communication with, one or more components of an agricultural implement, such as one or more of the components of the implement 10 described above. For example, as shown in FIG. 5, the system 200 may include one or more bearing sensors (e.g., the bearing sensors 100 described above) configured to provide data indicative of one or more bearing-related parameters associated with the bearing(s) 64. Further, the system 200 may be in communication with implement actuators, such as the actuator(s) 49 for adjusting the penetration depth of the associated disk gang assembly(ies) 44. Furthermore, the system 200 may be in communication with one or more drive component(s) of a work vehicle towing the implement, such as the engine 24 and/or transmission 26 of the work vehicle 12. Moreover, the system 200 may be in communication with a user interface, such as the user interface 23. It should be appreciated that the user interface(s) 23 may include one or more feedback devices (not shown), such as display screens, speakers, warning lights, and/or the like. In addition, some embodiments of the user interface(s) 23 may include one or more input devices (not shown), such as touchscreens, keypads, touchpads, knobs, buttons, sliders, switches, mice, microphones, and/or the like, for allowing an operator to provide inputs to the system 200. Additionally, the system 200 may be in communication with one or more ground speed sensors, such as ground speed sensor(s) 130 configured to generate data indicative of the ground speed of the implement 10. In one embodiment, the ground speed sensor 130 may correspond to a GPS device or any other suitable satellite navigation position system configured to generate data associated with the ground speed of the implement 10. In another embodiment, the ground speed sensor(s) 130 may correspond to a rotary speed sensor(s) configured to monitor the rotational speed of a given component that provides an indication of the ground speed of the implement 10, such as the engine 24 or transmission 26 of the work vehicle 12 or a wheel of the vehicle 12 or implement 10.

In accordance with aspects of the present subject matter, the system 200 may also include a computing system 202 configured to execute various computer-implemented functions. In general, the computing system 202 may comprise any suitable processor-based device known in the art, such as a computing device or any suitable combination of computing devices. Thus, in several embodiments, the computing system 202 may include one or more processor(s) 204 and associated memory device(s) 206 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 206 of the computing system 202 may generally comprise memory element(s) including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 206 may generally be configured to store suitable computer-readable instructions that, when implemented by the processor(s) 204, configure the computing system 202 to perform various computer-implemented functions, such as one or more aspects of the methods or algorithms described herein. In addition, the computing system 202 may also include various other suitable components, such as a communications circuit or module, one or more input/output channels, a data/control bus and/or the like.

It should be appreciated that the computing system 202 may correspond to an existing computing system of the implement 10 or associated work vehicle 12 or the computing system 202 may correspond to a separate computing system. For instance, in one embodiment, the computing system 202 may form all or part of a separate plug-in module that may be installed in association with the implement 10 or work vehicle 12 to allow for the disclosed system 200 and related methods to be implemented without requiring additional software to be uploaded onto existing computing systems of the implement 10 and/or the work vehicle 12.

In several embodiments, the computing system 202 may be configured to monitor one or more bearing-related parameters (e.g., load) associated with the bearing(s) 64 of a given disk gang assembly 44 to determine when the bearing(s) 64 are likely experiencing a bearing failure condition. Specifically, in one embodiment, the computing system 202 may be communicatively coupled to the bearing sensors 100 (e.g., via a wired or wireless connection) to receive the data generated by the bearing sensor(s) indicative of the bearing-related parameter(s) (e.g., load) over a period of time. In general, the spatial (time) domain data generated by the bearing sensor(s) 100 may be noisy, which may make it difficult to identify cyclical bearing failure occurrences from other cyclical occurrences, such as engine cycling related ground speed oscillations, lateral seesawing of the disk gang assembly 44, C-hanger spring oscillations, down-pressure spring oscillations, and/or the like.

As such, the computing system 202 may analyze the data generated by the bearing sensor(s) 100 using one or more spectral analysis techniques to more easily identify the bearing failure related occurrences from other cyclical occurrences during the implement 10 operation. For instance, the computing system 202 may convert the data generated by the bearing sensor(s) 100 from the spatial (time) domain to the frequency domain using a spectral analysis technique, which makes it easier to identify cyclical frequencies. It should be appreciated that any suitable Fourier transformation technique, such as a Fast Fourier, Cooley-Tukey, Prime Factor, Bruun's, Rader's, Bluestein's, and/or Hexagonal techniques, or any other suitable spectral analysis techniques, such as the Bartlett's, Welch's, and/or Least-squares techniques, may be used to analyze the data generated by the sensor(s) 100. The converted data indicates a magnitude of different rotational frequencies, where the computing system 202 may evaluate the magnitude at a rotational frequency of the disks 46 (or a multiple of the rotational frequency of the disks 46) in the transformed data to determine if the associated bearing 64 is experiencing a bearing failure condition.

In some instances, the computing system 202 may compare the magnitude at the detected rotational frequency of the disks 46 associated with the bearing 64 in the transformed data to a baseline or maximum magnitude for the rotational frequency (e.g., as determined when the disk gang shaft 56 was known to be operating correctly) for the ground speed and/or penetration depth of the disks 46 to determine when the bearing 64 is likely experiencing a bearing failure condition. For instance, the computing system 202 may estimate or measure the rotational frequency of the disks 46 based at least in part on the ground speed of the implement 10. In such instances, the computing system 202 may determine that the bearing 64 is likely experiencing the bearing failure condition when the magnitude at the rotational frequency of the disks 46 associated with the bearing 64 is greater than the baseline magnitude by at least a threshold difference. The threshold magnitude difference may be, for example, about 50 or more, such as about 100, such as about 150 and/or the like. However, it should be appreciated that any suitable threshold difference may be used. Moreover, it should be appreciated that, in some instances, the computing system 202 may compare the magnitude at the rotational frequency of the disks 46 associated with the bearing 64 to more than one baseline magnitude, where the different baseline magnitudes may be associated with different severities of the bearing failure condition (e.g., partial bearing failure condition, complete bearing failure condition, and/or the like).

In one or more instances, the computing system 202 may additionally, or alternatively, compare the magnitude at the rotational frequency of the disks 46 associated with the bearing 64 to the magnitude at the rotational frequency of the disks 46 associated with one or more of the other bearings 64 of the same disk gang assembly 44 and determine when the bearing 64 is likely experiencing a bearing failure condition based at least in part on the comparison. For instance, when the magnitude at the rotational frequency of the disks 46 associated with the bearing 64 differs by at least a threshold amount from the magnitude at the rotational frequency of the disks 46 associated with the other bearing(s) 64 of the disk gang assembly 44, the computing system 202 may determine that the bearing 64 is likely experiencing the bearing failure condition. The threshold amount may be, for example, about or more, such as about 100, such as about 150 and/or the like. However, it should be appreciated that any suitable threshold amount may instead be used, and/or that multiple threshold amounts may be used to indicate different severities of the bearing failure condition.

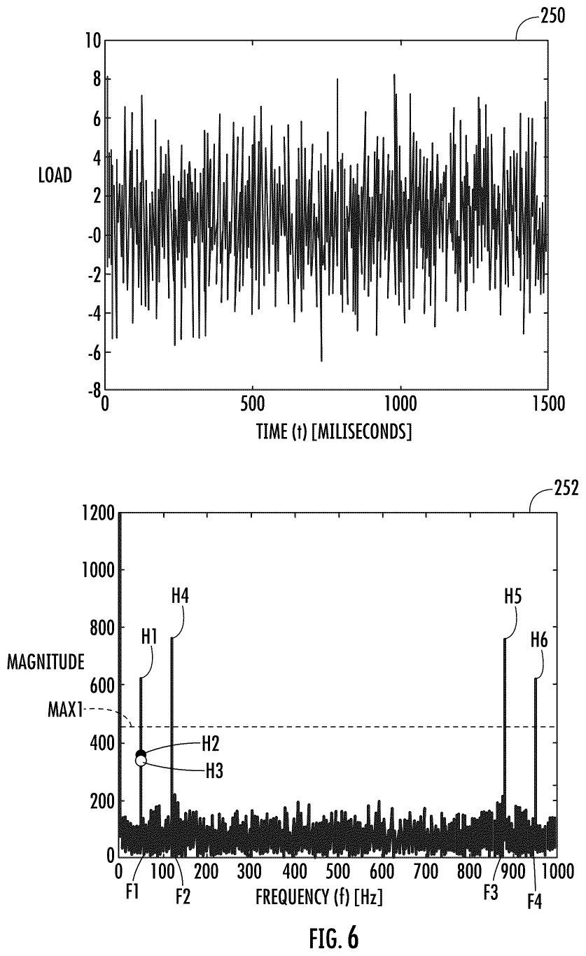

As an example of such analysis, the top plot 250 in FIG. 6 illustrates the load at a bearing over time whereas the bottom plot 252 in FIG. 6 illustrates the time domain data from the plot 250 converted using a Fast Fourier Transformation (FFT) technique into the frequency domain. In the bottom plot 252 of FIG. 6, there are several frequencies that have a significantly higher magnitude, particularly a first frequency F1 (e.g., having a frequency of about 50 Hertz [Hz]), a second frequency F2 (e.g., having a frequency of about 125 Hz), a third frequency F3 (e.g., having a frequency of about 875 Hz), and a fourth frequency F4 (e.g., having a frequency of about 950 Hz).

The computing system 202 determines that the rotational frequency of the disks 46 is close, or equal to, the first frequency F1 (e.g., 50 Hz), then compares the magnitude H1 at the first frequency F1 (e.g., about 600 at 50 Hz) to a baseline magnitude MAX1 for the first frequency F1 (e.g., about 425 at 50 Hz) associated with the maximum normal magnitude of the load at the current ground speed and/or penetration depth of the disks 46. The computing system 202 may determine that the bearing 64 is likely experiencing a bearing failure condition as the magnitude H1 at the first frequency F1 for the bearing 64 exceeds the baseline magnitude MAX1 by at least the threshold difference (e.g., by more than 50). Similarly, in some instances, the computing system 202 may compare the magnitude H1 of the bearing 64 at the first frequency F1 (e.g., about 600 at 50 Hz for the outer bearing 64) to an magnitude H2 of a first other bearing (e.g., about 375 at 50 Hz for the middle bearing 64) and/or an magnitude H3 of a second other bearing (e.g., about 350 at 50 Hz for the inner bearing 64), determined from data generated by other sensor(s) 100 and similarly transformed to the frequency domain. The computing system 202 may determine that the bearing 64 (e.g., outer bearing) is likely experiencing a bearing failure condition as the magnitude H1 at the first frequency F1 for the bearing 64 (e.g., outer bearing) differs from the magnitude(s) H2, H3 of the other bearing(s) 64 (e.g., middle and/or inner bearing(s)) by at least the threshold amount (e.g., by more than 150).

Moreover, referring back to FIG. 5, the computing system 202 may determine whether there are multiple instances of a bearing failure condition present at a particular bearing by evaluating the magnitude at multiples of the rotational frequency of the disks 46. For instance, if the bearing 64 starts to have one or more secondary points of sticking about the rotational axis 56A, the bearing 64 may only stick at these secondary points every nth rotation about the axis 56A at the start of such condition. As such, the computing system 202 may monitor the secondary magnitudes at multiples of the rotational frequency of the disks 46 to determine whether there is more than one instance of a bearing failure condition (e.g., when the secondary magnitude is more than the threshold difference from the baseline magnitude MAX1 and/or more than a threshold amount from the secondary magnitudes at the multiples of the rotational frequency for the other bearings 64).

In the example plot 252 of FIG. 6, for instance, the second frequency F2 (e.g., about 125 Hz) is not a multiple of the first frequency F1 (e.g., about 50 Hz), so the computing system 202 may determine that the magnitude H4 at the second frequency F2 is likely associated with another cyclical load on the disk gang assembly 44, such as by the engine cycling. The third frequency F3 (e.g., about 875 Hz) is also not a multiple of the first frequency F1, as such the computing system 202 may determine that the magnitude H5 at the second frequency F2 is likely associated with another cyclical load on the disk gang assembly 44, such as another cyclical load by the engine cycling or from see sawing of the disk assembly 44. The fourth frequency F4 (e.g., about 950 Hz) is a multiple of the first frequency F1 (e.g., about 50 Hz), as such that computing system 202 may determine that the bearing 64 is likely experiencing at least one other instance of the bearing failure condition, as the secondary magnitude H6 at the fourth frequency F4 is also greater than the baseline magnitude MAX1 and/or as the other bearings are not experiencing a spike at the fourth frequency F4.

Referring back to FIG. 5, when the computing system 202 determines that the bearing(s) 64 is experiencing one or multiple instances of a bearing failure condition, the computing system 202 is configured to automatically perform one or more control actions associated with the agricultural implement 10. For instance, in one embodiment, the control action may include the computing system 202 controlling an operation of the user interface(s) 23 to indicate the bearing(s) 64 that is experiencing the bearing failure condition (e.g., by causing a visual or audible notification or indicator to be presented). Similarly, in one or more embodiments, the control action may include the computing system 202 being configured to additionally, or alternatively, control an operation of the actuator(s) 49 to change (e.g., reduce) a penetration depth of the disk gang assembly(ies) 44 having the bearing(s) 64 experiencing the bearing failure condition. In some embodiments, the control action may include the computing system 202 being configured to additionally, or alternatively, control an operation of the drive component(s) 24, 26 of the work vehicle 12 to slow down or stop the implement 10 and vehicle 12.

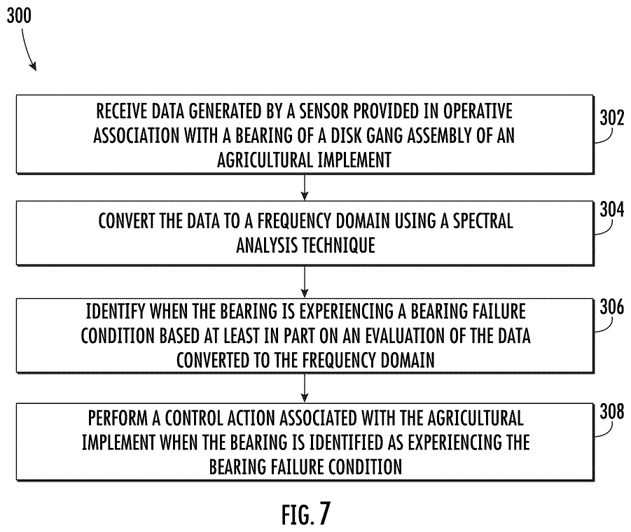

Referring now to FIG. 7, a flow diagram of one embodiment of a method 300 for detecting bearing failures for a disk gang assembly of an agricultural implement is illustrated in accordance with aspects of the present subject matter. In general, the method 300 will be described herein with reference to the agricultural implement 10 and the disk gang assemblies 44 described above with reference to FIGS. 1-4, and the system 200 described above with reference to FIGS. 5-6. However, it should be appreciated by those of ordinary skill in the art that the disclosed method 300 may generally be utilized in association with agricultural implements having any suitable implement configuration, tool assemblies having any other suitable tool configuration and/or systems having any other suitable system configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (302), the method 300 may include receiving data generated by a sensor provided in operative association with a bearing of a disk gang assembly of an agricultural implement. For instance, as described above, the computing system 202 may be configured to receive data generated by the bearing sensor(s) 100 provided in operative association with one or more of the bearing(s) 64 of at least one disk gang assembly 44 of the agricultural implement 10, where, for example, the data may be indicative of a load on the bearing(s) 64 in a time domain.

Further, at (304), the method 300 may include converting the data to a frequency domain using a spectral analysis technique. For example, as discussed above, the computing system 202 may convert the data generated by the bearing sensor(s) 100 from a time domain to a frequency domain using a spectral analysis technique, such as a Fourier transform technique and/or the like.

At (306), the method 300 may include identifying when the bearing is experiencing a bearing failure condition based at least in part on an evaluation of the data converted to the frequency domain. For instance, as discussed above, the computing system 202 may identify when the bearing(s) 64 is experiencing one or more instances of the bearing failure condition based at least in part on an evaluation of the data converted to the frequency domain. For example, the computing system 202 may evaluate the magnitude of each of the monitored bearing(s) at the rotational frequency of the disk gang assembly 44 to determine if the bearing(s) are experiencing at least one instance of the bearing failure condition.

Additionally, at (308), the method 300 may include performing a control action associated with the agricultural implement when the bearing is identified as experiencing the bearing failure condition. For example, as described above, the computing system 202 may perform a control action associated with the agricultural implement 10, such as controlling an operation of the user interface(s) 23, an operation of the actuator(s) 49 for the disk gang assembly(ies) 44 associated with the bearing(s) 64, an operation of the drive component(s) 24, 26, and/or the like, when the bearing(s) 64 is identified as experiencing the bearing failure condition.

It is to be understood that the steps of the method 300 are performed by the computing system 202 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 202 described herein, such as the method 300, is implemented in software code or instructions which are tangibly stored on a tangible computer readable medium. The computing system 202 loads the software code or instructions via a direct interface with the computer readable medium or via a wired and/or wireless network. Upon loading and executing such software code or instructions by the computing system 202, the computing system 202 may perform any of the functionality of the computing system 202 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for detecting bearing failures for disk gang assemblies of an agricultural implement, the system comprising:
a disk gang assembly comprising:
a shaft;
a bearing rotatably supporting the shaft for rotation about a rotational axis; and
a plurality of disks supported on the shaft for rotation with the shaft about the rotational axis;
a sensor provided in operative association with the bearing, the sensor being configured to generate data indicative of a bearing-related parameter; and
a computing system configured to:
receive the data generated by the sensor;
convert the data to a frequency domain using a spectral analysis technique; and
identify when the bearing is experiencing a bearing failure condition based at least in part on an evaluation of the data converted to the frequency domain.

2. The system of claim 1, wherein the data converted to the frequency domain indicates a magnitude at a detected rotational frequency, and
wherein the computing system is configured to identify that the bearing is experiencing the bearing failure condition when the magnitude at the detected rotational frequency is greater than a baseline magnitude by at least a threshold difference.

3. The system of claim 2, wherein the data converted to the frequency domain indicates a secondary magnitude at a multiple of the detected rotational frequency, and
wherein the computing system is configured to identify that the bearing is experiencing multiple instances of the bearing failure condition when the secondary magnitude at the multiple of the detected rotational frequency is also greater than the baseline magnitude by at least the threshold difference.

4. The system of claim 2, wherein the detected rotational frequency is a rotational frequency of the plurality of disks.

5. The system of claim 1, further comprising:
a second bearing rotatably supporting the shaft for rotation about the rotational axis, the second bearing being spaced apart along the rotational axis from the bearing; and
a second sensor provided in operative association with the second bearing, the second sensor being configured to generate second data indicative of the bearing-related parameter for the second bearing,
wherein the computing system is further configured to:
receive the second data generated by the second sensor;
convert the second data to the frequency domain using the spectral analysis technique; and
identify when the second bearing is experiencing the bearing failure condition based at least in part on an evaluation of the second data converted to the frequency domain.

6. The system of claim 5, wherein the bearing is a first bearing,
wherein the sensor is a first sensor, and the data generated by the first sensor is first data, and
wherein the computing system is configured to identify that the one of the first bearing or the second bearing is experiencing the bearing failure condition based at least in part on a comparison of the first data converted to the frequency domain and the second data converted to the frequency domain.

7. The system of claim 1, wherein the spectral analysis technique is Fourier transformation.

8. The system of claim 1, wherein the sensor comprises a draft load sensor, the data being indicative of a load on the bearing.

9. The system of claim 1, wherein the sensor directly contacts the bearing.

10. The system of claim 1, wherein the computing system is configured to perform a control action associated with the agricultural implement when the bearing is identified as experiencing the bearing failure condition.

11. A method for detecting a bearing failure condition for a disk gang assembly of an agricultural implement, the disk gang assembly comprising a shaft, a bearing rotatably supporting the shaft for rotation about a rotational axis, and a plurality of disks supported on the shaft for rotation with the shaft about the rotational axis, the method comprising:
receiving, with a computing system, data generated by a sensor provided in operative association with the bearing, the data being indicative of a bearing-related parameter;
converting, with the computing system, the data to a frequency domain using a spectral analysis technique;
identifying, with the computing system, when the bearing is experiencing a bearing failure condition based at least in part on an evaluation of the data converted to the frequency domain; and
performing, with the computing system, a control action associated with the agricultural implement when the bearing is identified as experiencing the bearing failure condition.

12. The method of claim 11, wherein the data converted to the frequency domain indicates a magnitude at a detected rotational frequency, and
wherein identifying when the bearing is experiencing the bearing failure condition comprises identifying that the bearing is experiencing the bearing failure condition when the magnitude at the detected rotational frequency is greater than a baseline magnitude by at least a threshold difference.

13. The method of claim 12, wherein the data converted to the frequency domain indicates a secondary magnitude at a multiple of the detected rotational frequency, and
wherein identifying when the bearing is experiencing the bearing failure condition comprises identifying that the bearing is experiencing multiple instances of the bearing failure condition when the secondary magnitude at the multiple of the detected rotational frequency is also greater than the baseline magnitude by at least the threshold difference.

14. The method of claim 12, wherein the detected rotational frequency is a rotational frequency of the plurality of disks.

15. The method of claim 11, further comprising:
receiving, with the computing system, second data generated by a second sensor provided in operative association with a second bearing rotatably supporting the shaft for rotation about the rotational axis, the second bearing being spaced apart along the rotational axis from the bearing, the second data being indicative of the bearing-related parameter for the second bearing;
converting, with the computing system, the second data to the frequency domain using the spectral analysis technique; and
identifying, with the computing system, when the second bearing is experiencing the bearing failure condition based at least in part on an evaluation of the second data converted to the frequency domain.

16. The method of claim 15, wherein receiving the data generated by the sensor provided in operative association with the bearing comprises receiving first data generated by a first sensor provided in operative association with a first bearing, and
wherein identifying when the bearing is experiencing a bearing failure condition comprises identifying when the one of the first bearing or the second bearing is experiencing the bearing failure condition based at least in part on a comparison of the first data converted to the frequency domain and the second data converted to the frequency domain.

17. The method of claim 11, wherein converting the data to the frequency domain using the spectral analysis technique comprises converting the data to the frequency domain using Fourier transformation.

18. The method of claim 11, wherein receiving the data generated by the sensor provided in operative association with the bearing comprises receiving the data from a draft load sensor, the data being indicative of a load on the bearing.

19. The method of claim 11, wherein performing the control action comprises controlling an operation of a user interface associated with the agricultural implement to indicate that the bearing is identified as experiencing the bearing failure condition.

20. The method of claim 11, wherein performing the control action comprises automatically controlling an operation of the agricultural implement.
